(19) United States
(12) Patent Application Publication
(10) Pub. No.: US 2011/0199172 A1
(43) Pub. Date: Aug. 18, 2011

(54) MAGNETIC YOKE, MICROMECHANICAL COMPONENT, AND METHOD FOR THE MANUFACTURE THEREOF

(76) Inventors: Tjalf Pirk, Stuttgart (DE); Stefan Pinter, Reutlingen (DE); Joerg Muchow, Reutlingen (DE); Joachim Fritz, Tuebingen (DE); Christoph Friese, Reutlingen (DE)

(21) Appl. No.: 12/737,894

(22) PCT Filed: Aug. 3, 2009
(86) PCT No.: PCT/EP2009/060020

§ 371 Date: May 4, 2011

(30) Foreign Application Priority Data
Sep. 25, 2008 (DE) 102008042346.7

(51) Int. Cl. H01F 3/00; H01F 7/06; B23P 11/00

(52) U.S. Cl. 335/297; 29/605; 29/428

(57) ABSTRACT

A magnetic yoke (10) having a magnet (12) having a magnetization direction (14) on which a first yoke arm (18a) and a second yoke arm (18b) are mounted in such a way that the magnet (12) and the two yoke arms (18a, 18b) define a yoke intermediate space (20) extending from a front side to a rear side of the magnetic yoke; and first pole shoe (22a) configured on the first yoke arm (18a) and a second pole shoe (22b) configured on the second yoke arm (18b), between which a yoke gap (24) is located; the first pole shoe (22a) having a first width (b1) at a first end (40a) on the front side of the magnetic yoke (10), in parallel to the magnetization direction (14) of the magnet (12), and having a second width (b2) unequal to the first width (b1) at a second end (42a) facing opposite the first end (40a) on the rear side of the magnetic yoke (10), in parallel to the magnetization direction (14) of the magnet (12).

### BACKGROUND OF THE INVENTION

1. Field of the Invention

The present invention relates to a magnetic yoke. The present invention also relates to a micromechanical component. Moreover, the present invention relates to a method for manufacturing a magnetic yoke and to a method for manufacturing a micromechanical component.

2. Description of Related Art

To permit adjustment of an adjustable control element relative to a fixedly mounted holder, a micromechanical component can have a magnetic drive, an electrostatic drive and/or a piezoelectric drive. The adjustable control element is a mirror plate, for example, which is adjustable by the drive about at least one rotational axis, preferably about two rotational axes.

In comparison to a comparable component having an electrostatic drive, a micromechanical component having a magnetic drive has the advantage that comparatively high torques can be achieved at technically reasonable current intensities of less than 100 mA. To achieve comparable torques using electrostatic comb drives, voltages within a range of several 100V are required at gap intervals of approximately 5 μm. From a technical standpoint, it is relatively costly to realize such voltages, especially as there are risks of a sparkover or pull-in. Another advantage of a magnetic drive over an electrostatic drive is the Lorentz force which, in a first approximation, is linear relative to the applied voltage.

However, when working with a micromechanical component having a magnetic drive, the assembly and joining techniques are often relatively costly. Therefore, considerable effort must be expended, in particular, to manufacture a micromechanical component having a magnetic drive and a control element that is adjustable about two rotational axes.

The published European patent document EP 77 8 657 B1 and the published international patent application document WO 2005/078509 A2 each describe a magnetic drive for adjusting a control element. In order for the control element to be adjustable about two rotational axes, the magnetic drives have a plurality of permanent magnets which, in one preferred setting, must be positioned at a relatively small distance from one another. In the preferred setting, the permanent magnets should be positioned in relation to one another in such a way that the magnetization directions of the permanent magnets are not oriented in parallel to one another. Thus, when manufacturing the magnetic drives, repulsion forces arise between the permanent magnets. This makes the manufacturing of magnetic drives relatively work-intensive and complicated. In particular, bonding processes are not possible in this context.

Moreover, the magnetic drives described in the published European patent document EP 77 8 657 B1 and the published international patent application document WO 2005/078509 A2 have a relatively large volume. This makes it difficult to install them in an electronic component.

### SUMMARY OF THE INVENTION

The present invention provides a magnetic yoke, micromechanical components, a manufacturing method for a magnetic yoke, and a manufacturing method for a micromechanical component.

A magnetic yoke (10) having a magnet (12) having a magnetization direction (14) on which a first yoke arm (18a) and a second yoke arm (18b) are mounted in such a way that the magnet (12) and the two yoke arms (18a, 18b) define a yoke intermediate space (20) extending from a front side to a rear side of the magnetic yoke; and having a first pole shoe (22a) configured on the first yoke arm (18a) and a second pole shoe (22b) configured on the second yoke arm (18b), between which a yoke gap (24) is located; the first pole shoe (22a) having a first width (b1) at a first end (40a) on the front side of the magnetic yoke (10), in parallel to the magnetization direction (14) of the magnet (12), and having a second width (b2) unequal to the first width (b1) at a second end (42a) facing opposite the first end (40a) on the rear side of the magnetic yoke (10), in parallel to the magnetization direction (14) of the magnet (12).

### BRIEF DESCRIPTION OF THE DRAWINGS

Other features and advantages of the present invention are explained in greater detail in the following with reference to the figures, which show:

FIGS. 1A and 1B show a cross section and a plan view for illustrating a specific embodiment of the magnetic yoke.

FIGS. 2A and 2B show a plan view and a lateral view of an intermediate frame for illustrating a first specific embodiment of the micromechanical component.

FIG. 3 shows a lateral view for illustrating a second specific embodiment of the micromechanical component.

FIGS. 4A and 4B show a front and a rear side of an intermediate frame including a control element designed as a mirror plate.

FIG. 5 shows a cross section for illustrating a third specific embodiment of the micromechanical component.

FIG. 6 shows a cross section for illustrating a fourth specific embodiment of the micromechanical component.

FIG. 7 shows a cross section for illustrating a fifth specific embodiment of the micromechanical component.

FIG. 8 shows a detail of a cross section for illustrating a sixth specific embodiment of the micromechanical component.

FIG. 9 shows a cross section through an outer frame for illustrating a seventh specific embodiment of the micromechanical component.

### DETAILED DESCRIPTION OF THE INVENTION

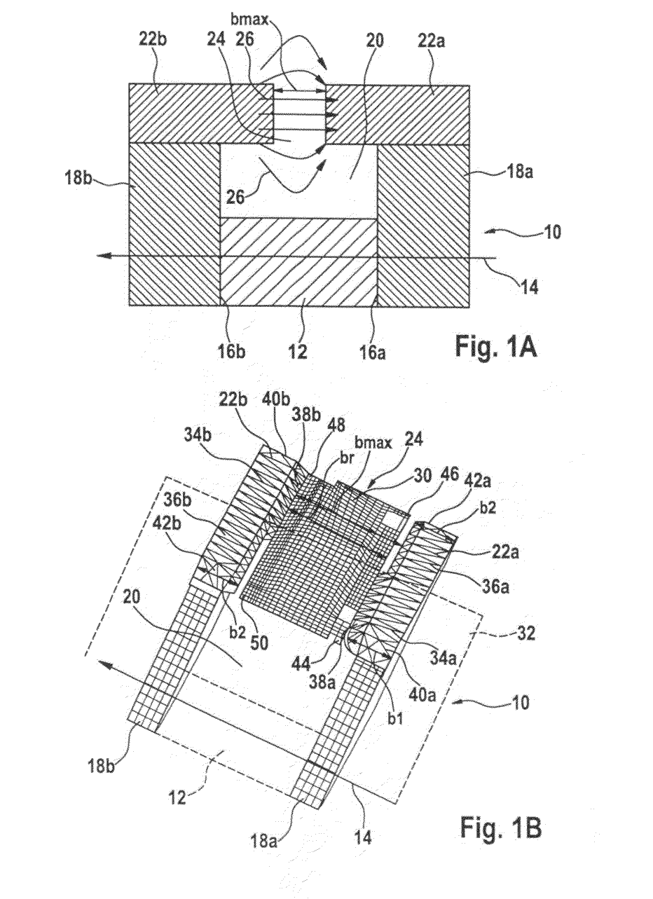

FIGS. 1A and 1B show a cross section and a plan view for illustrating a specific embodiment of the magnetic yoke.

Magnetic yoke 10 schematically reproduced in cross section in FIG. 1A encompasses a hard magnet 12 having a magnetization direction 14. Hard magnet 12 may be a permanent magnet. In the same way, once magnetic yoke 10 is assembled from its individual components described in the following, hard magnet 12 may be magnetized in a magnetization process.

Magnetization direction 14 extends from a first lateral surface 16a to a second lateral surface 16b of hard magnet 12. A yoke arm 18a and 18b of a soft magnetic material is fixedly mounted at each of the two lateral surfaces 16a and 16b. The two yoke arms 18a and 18b extend from hard magnets 12 in one common direction and thereby define a yoke intermediate space 20. Therefore, the width of yoke intermediate space 20 along magnetization direction 14 equals the width of hard magnet 12 between lateral surfaces 16a and 16b.

Fixedly mounted at both ends of yoke arms 18a and 18b facing opposite hard magnet 12 are pole shoes 22a and 22b, which, however, are only sketched schematically in FIG. 1A. Pole shoes 22a and 22b are preferably formed from a soft magnetic material. The design and the form of pole shoes 22a and 22b are discussed in greater detail in the description of FIG. 1B.

Pole shoes 22a and 22b may be formed in one piece together with corresponding yoke arm 18a or 18b. The depiction of pole shoes 22a and 22b, including yoke arms 18a and 18b as two individual components, is selected here merely for the sake of clarity.

The two pole shoes 22a and 22b are mounted in a mutually spaced-apart configuration on yoke arms 18a and 18b. A yoke gap 24 is located between first pole shoe 22a configured on first yoke arm 18a and second pole shoe 22b configured on second yoke arm 18b. In parallel to magnetization direction 14, yoke gap 24 has a maximum width bmax that is smaller than the distance between the two lateral surfaces 16a and 16b. A magnetic field having magnetic field lines 26 is present in yoke gap 24. Field lines 26 of the magnetic field within yoke gap 24 are directed counter to magnetization direction 14.

To provide a more precise description of pole shoes 22a and 22b, a plan view of magnetic yoke 10 is shown in FIG. 1B. For the sake of clarity, hard magnet 12 in FIG. 1B is only shown in dashed lines.

It is discernible in FIG. 1B that maximum width bmax of yoke gap 24 is selected to be larger than a width br of an intermediate frame 30. Thus, intermediate frame 30 may be mounted within yoke gap 24 of magnetic yoke 10 (see FIG. 1B). The design and function of intermediate frame 30 are discussed in greater detail below.

A median plane 32 may be defined for magnetic yoke 10 that is oriented in parallel to magnetization direction 14 and that intersects hard magnets 12 and the two yoke arms 18a and 18b. Median plane 32 preferably extends in the center, in parallel to the field lines, both through hard magnet 12, as well as through the two yoke arms 18a and 18b. In particular, median plane 32 may divide hard magnet 12 and/or at least one of the two yoke arms 18a and 18b into two mutually symmetric halves.

On the other hand, pole shoes 22a and 22b of magnetic yoke 10 are designed in such a way that their mass distribution is not symmetric relative to median plane 32. Therefore, magnetic yoke 10 may be referred to as an asymmetric magnetic yoke.

For example, median plane 32 subdivides a pole shoe 22a into a first half 34a and a second half 36a; in comparison to second half 36a, first half 34a having a supplementary mass 38a which projects into yoke gap 24. Supplementary mass 38a is preferably formed from a material having good magnetic flux properties. Supplementary mass 38a may be formed in one piece together with pole shoe 22a. It is pointed out here, however, that pole shoes 22a and 22b may be composed of a plurality of components that are configured so as to be at least partially mutually spaced apart.

Supplementary mass 38a or 38b preferably extends in one direction perpendicularly to width bmax of yoke gap 24 along entire first half 34a or 34b. It is self-evident that supplementary mass 38a may also have smaller dimensions in one direction extending perpendicularly to maximum width bmax.

In the illustrated example of FIG. 1B, median plane 32 subdivides both pole shoes 22a and 22b, in each case into a first half 34a or 34b having supplementary mass 38a or 38b and a second half 36a or 36b without a supplementary mass 38a or 38b. In the same way, however, a magnetic yoke may also be feasible where median plane 32 subdivides only one pole shoe 22a or 22b into a first half 34a or 34b having a supplementary mass 38a or 38b opposite second half 36a or 36b. In this case, the other pole shoe 22a or 22b may have a mass distribution that is symmetric relative to median plane 32.

The asymmetry of pole shoes 22a and 22b may also be described in that a front side and a rear side of magnetic yoke 10 are defined, yoke intermediate space 20 and yoke gap 24 extending from the front side to the rear side. The first of the two pole shoes 22a has a first lateral surface 40a at the front side and a second lateral surface 42a at the rear side. In one direction extending in parallel to maximum width bmax, first lateral surface 40a of pole shoe 22a has a first width b1. In the direction extending in parallel to maximum width bmax, the second side of first pole shoe 22a has a second width b2 unequal to first width b1. For example, first width b1 is greater than second width b2 (see the example of FIG. 1B).

In this context, first pole shoe 22a extends oppositely to first yoke arm 18a at first lateral surface 40a by a first height into yoke gap 24. However, at second lateral surface 42a, first pole shoe 22a extends by a second height, which is unequal to the first height, into yoke gap 24.

Correspondingly, at the rear side, second pole shoe 22b may also have a first lateral surface 40b having first width b1 and, at the front side, a second lateral surface 42b having second width b2. It is pointed out here, however, that a point-symmetric formation of the two pole shoes 22a and 22b is not required for the described technique.

The asymmetric formation of pole shoes 22 produces a magnetic field in yoke gap 24 that is asymmetric relative to median plane 32; however, the field lines of the magnetic field not being marked in FIG. 1B for the sake of clarity. Four corners 44 through 50 are defined illustratively for intermediate frame 30, corners 44 and 46 being configured adjacently to first pole shoe 22a, and corners 48 and 50 being configured adjacently to second pole shoe 22b. Corner 48 is disposed diagonally opposite corner 44. Accordingly, the two corners 46 and 50 also define a diagonal of intermediate frame 30. It is expressly pointed out here that the term corner does not suggest any edge-shaped formation of corners 44 through 50. For example, corners 44 through 50 may also be constituted of round sections of intermediate frame 30.

Due to the asymmetric formation of pole shoes 22a and 22b, the distance between corners 44 and 46 to first pole shoe 22a varies. For example, corner 44 has a smaller distance to first pole shoe than does corner 46. Thus, at corner 44, the magnetic field has a different field strength than at corner 46.

Accordingly, a distance between corner 48 and second pole shoe 22b is also unequal to a distance between corner 50 and second pole shoe 22b. Thus, the local field strength of the magnetic field at corner 48 is unequal to the local field strength of the magnetic field at corner 50. This unequal distribution of the field strength of the magnetic field with respect to selected regions of intermediate frame 30, for example, of corners 44 through 50, elicits the advantages described below.

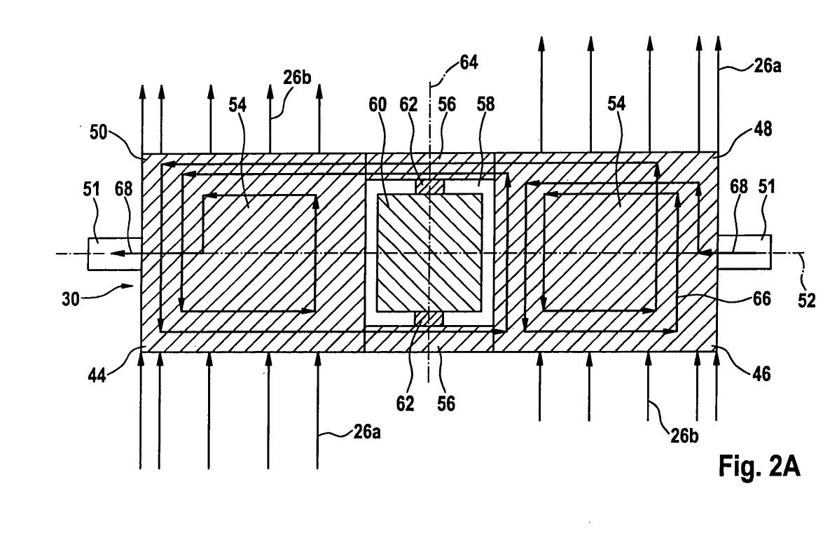

FIGS. 2A and 2B show a plan view and a lateral view of an intermediate frame for illustrating a first specific embodiment of the micromechanical component.

Intermediate frame 30 (inner plate) schematically reproduced in FIG. 2A is connected via two outer springs 51 to a holder (to an outer frame) (not shown). The holder encompasses a magnetic yoke (not shown) that is designed as an asymmetric magnetic yoke. Thus, intermediate frame 30 is fixed in the magnetic yoke. The magnetic yoke corresponds to the specific embodiment of FIGS. 1A and 1B, for example. Therefore, the design of the magnetic yoke is not discussed here in greater detail.

The two outer springs 51 extend along a first rotational axis 52, about which intermediate frame 30 is rotatable opposite the holder. The two outer springs 51 are designed as torsion springs, for example.

At one side adjacent to a first pole shoe of the magnetic yoke, intermediate frame 30 has corners 44 and 46 and, at one side adjacent to a second pole shoe of the magnetic yoke, it has corners 48 and 50. Corners 44 and 48 and corners 46 and 50 are disposed diagonally opposite one another. Intermediate frame 30 is mounted via outer springs 51 inside the yoke gap of the magnetic yoke in such a way that corner 44 has a smaller first distance to the first pole shoe than does corner 46. Accordingly, the distance between corner 48 and second pole shoe is also smaller than the distance between corner 50 and the second pole shoe.

Due to the different distances between corners 44 and 46 (respectively, 48 and 50) and the respective adjacent pole shoe, the magnetic field of the magnetic yoke at corners 44 through 50 has unequal field strengths. As is illustrated in FIG. 2A by magnetic field lines 26a, the magnetic field has a comparatively high field strength at diagonally opposed corners 44 and 48. In contrast, the magnitude of the magnetic field at corners 46 and 50, which define a diagonal of intermediate frame 30, is comparatively low (see magnetic field lines 26b).

Intermediate frame 30 encompasses two lateral plates 54 which are interconnected via two connecting webs 56. In this context, the outer side of one connecting web 56 preferably extends along an outer side of the two lateral plates 54. Thus, the two lateral plates 54 and the two connecting webs 56 define an opening 58 in which a control element 60, for example a mirror plate, is configured. Control element 60 is connected by at least one inner spring 62 to intermediate frame 30. For example, an inner spring 62 extends from each of the two connecting webs 56 to control element 60. Inner springs 62, preferably designed as torsion springs, extend along a second rotational axis 64 that is not oriented in parallel to first rotational axis 52. Second rotational axis 64 preferably extends perpendicularly to first rotational axis 52.

Intermediate frame 30 may be formed in one piece together with components 54 and 56. Intermediate frame 30, together with springs 51 and 62 and control element 60, is preferably constructed from a silicon layer. In addition, holder components may also be formed from the silicon layer.

Intermediate frame 30 may, for example, have a length along first rotational axis 52 of approximately 12 mm and a width along second rotational axis 64 of approximately 4 mm. Inner springs 62 and outer springs 51 preferably have a length of 400 to 500 μm. Control element 60 may have a diameter of 1 to 2 mm, for example. This comparatively wide intermediate frame 30 even exhibits good mechanical stability when working with manufacturing steps, such as sawing or bonding, for example.

A coil, which is able to be supplied with an electric current, is configured as conductor lines 66 on intermediate frame 30. Conductor lines 66 are patterned from a conductive layer, for example. A sensing device is connected via additional supply leads, which extend in each case over one of the two outer springs 51. The control device is designed to control the current intensity of the current flowing through conductor lines 66.

Intermediate frame 30 is subdividable by first rotational axis 52 and second rotational axis 64 into four quadrants I through IV, of which a first and a second quadrant I and II are disposed adjacently to the first pole shoe, and a third and a fourth quadrant III and IV are disposed adjacently to the second pole shoe. Due to the asymmetric formation of the magnetic yoke, conductor lines 66 of quadrants I through IV feature at least two different mean distances to the nearest pole shoe. Thus, a mean distance of conductor lines 66 of first quadrant I to the first pole shoe is smaller than a mean distance of conductor lines 66 of second quadrant II to the first pole shoe. Correspondingly, a mean distance of conductor lines 66 of third quadrant III to the second pole shoe is smaller than a mean distance of conductor lines 66 of fourth quadrant IV to the second pole shoe.

As a result, at least two different mean magnetic field strengths are present in the areas of conductor lines 66 of quadrants I through IV. The mean magnetic field strength in the areas of conductor lines 66 of quadrants I and III has a value of 0.5 T, while a mean magnetic field strength of approximately 0.35 T is present in the areas of conductor lines 66 of quadrants II and IV.

Thus, a current flow through conductor lines 66 produces different Lorentz forces and, thus, also different torques M1 through M4 acting on quadrants I through IV. This is schematically illustrated in FIG. 2B. For the sake of clarity, control element 60 and inner springs 62 are not sketched in the drawing.

For example, the magnitudes of torques M1 and M3 of quadrants I and III are distinctly greater than those of torques M2 and M4 of quadrants II and IV. When conductor lines 66 are supplied with current, the magnitudes of torques M1 and M3 of quadrants I and III are preferably 30% greater than those of torques M2 and M4 of quadrants II and IV. In this context, torques M1 and M2 of quadrants I and II are directed in one direction. Torques M3 and M4 of quadrants III and IV are directed counter to the direction of the torques of quadrants I and II.

Since torques M1 through M4 act on quadrants I through IV at mutually deviating magnitudes, the generated rotary motion of control element 60 is a sum of a first partial rotation about first rotational axis 51 and of a second partial rotation about second rotational axis 64.

A particularly advantageous method for adjusting the control element is described in the following: To effect a rotation about second rotational axis 64 (resonant axis), cardanically suspended control element 60 is excited by a comparatively high resonance frequency, for example in the kHz range, such as at approximately 20 kHz. In contrast, in the case of a significantly lower frequency, for example at 60 Hz, the control element is adjusted (quasi-static mode) about first rotational axis 52 (static axis).

Since the rotations about the resonant axis and the static axis are excited via a single coil device formed from conductor lines 66, the control concept is comparatively simple. In the process, the high-frequency control signal and the quasi-static control signal are superimposed. Correspondingly, two coils may also be supplied with the respective signals.

The specific embodiment described here has the additional advantage that only one hard magnet having one magnetization direction for the magnetic yoke is used. Thus, when assembling the magnetic drive, there is no need to overcome any opposite repulsion forces of a plurality of magnets. Moreover, it is possible for the hard magnet to be installed in a non-magnetic state and then magnetized only following assembly in an external field.

The comparatively high field strength attainable in this manner makes it possible to adequately supply conductor lines 66 with current at a lower current intensity. In the area of conductor lines 66, the magnetic field is preferably virtually gradient-free in the vertical direction (perpendicularly to rotational axes 52 and 64). The coil formed from conductor lines 66 may, for example, have a number of winding turns of 10, for example. In this case, current flowing through conductor lines 66 at a current intensity of 50 mA produces a torque M1 or M3 of approximately 5 to 6 μNm.

A low current intensity ensures a longer-term usability of the micromechanical component since excessively high currents often lead to an overheating of conductor lines 66 and thus to damage of the same.

Accordingly, fewer conductor lines 66 may also be formed for the coil device, it nevertheless being possible for force to be uniformly generated. The thereby ensured reduction in the number of windings of conductor lines 66 makes a reduced resistance possible.

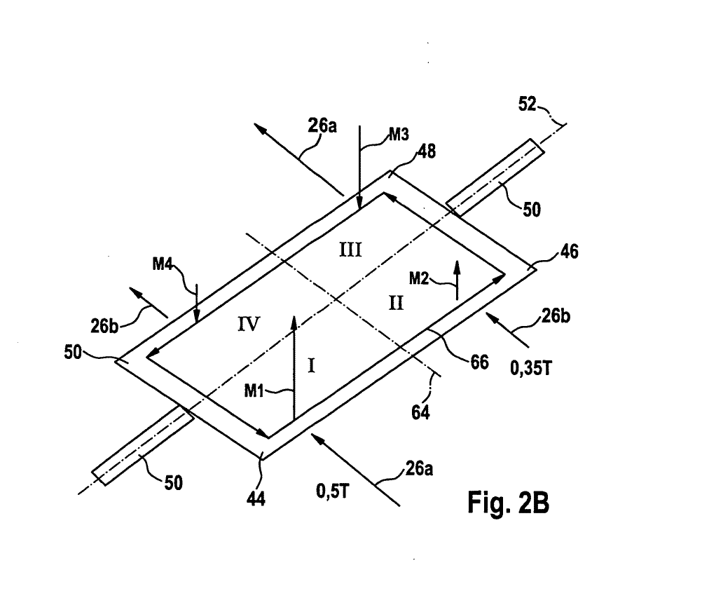

FIG. 3 shows a lateral view for illustrating a second specific embodiment of the micromechanical component.

Illustrated micromechanical component 100 includes a magnetic yoke composed of a hard magnet 12, yoke arms 18a and 18b, and pole shoes 102a and 102b. In contrast to the pole shoes described above, pole shoes 102a and 102b are each configured symmetrically to a median plane of the magnetic yoke. For the sake of clarity, however, the median plane, which subdivides hard magnet 12, yoke arms 18a and 18b, and pole shoes 102a and 102b in each case into two mutually symmetrical parts, is omitted in FIG. 3.

Yoke gap 104 located between pole shoes 102a and 102b may be subdivided by a center line 106 into two parts, a first part being adjacent to a first pole shoe 102a and a second part adjacent to second pole shoe 102b. Pole shoes 102a and 102b are each mounted at the same distance to center line 106 of yoke gap 104 on their corresponding yoke arms 18a and 18b.

An intermediate frame 30 having an adjustable control element is configured in yoke gap 104. However, the individual components of intermediate frame 30 are omitted in the example of FIG. 3.

The control element of intermediate frame 30 is adjustable about two-rotational axes 108 and 110, which are preferably oriented at an angle of 90° to one another. The control element is adjusted about at least one of the two rotational axes 108 and 110 by a current flow through conductor lines that are permanently configured on intermediate frame 30.

In the case of micromechanical component 100, intermediate frame 30 is positioned in its initial currentless position in yoke gap 104 in such a way that center line 106 lies in a plane defined by the two rotational axes 108 and 110. At the same time, the two rotational axes 108 and 110 are oriented relative to center line 106 at an inclination angle α1 or α2 unequal to 0° and unequal to 90°.

The position of intermediate frame 30 in yoke gap 104 may also be described in such a way that the lateral outer surfaces of intermediate frame 30 have a slanting orientation opposite the contact surfaces of pole shoes 102a and 102b, which adjoin yoke gap 104. Thus, intermediate frame 30 is obliquely/transversely situated in yoke gap 104.

Thus, corners 112 through 118 of intermediate frame 30 have different distances to their nearest pole shoe 102a or 102b. For example, corner 112 features a greater distance to adjacent first pole shoe 102a than does second corner 114a. In the same way, corner 116 diagonally opposing corner 112 is situated in greater proximity to second pole shoe 102b than is corner 118 diagonally opposing corner 114.

In this specific embodiment as well, intermediate frame 30 may be subdivided by rotational axes 108 and 110 into four quadrants; conductor lines (not sketched) of the quadrants having different mean distances to nearest pole shoe 102a or 102b. Accordingly, different mean magnetic field strengths are present in the areas of the conductor lines of the quadrants. This renders possible the advantageous operating method of micromechanical component 100 described with reference to the preceding example.

In another specific embodiment of the micromechanical component not graphically illustrated here, the conductor lines of the coil device may have an asymmetric design relative to at least one of the two rotational axes. For example, a different distance of the conductor lines from a first rotational axis may result in at least two different mean magnetic field strengths being present in the areas of the conductor lines of the four quadrants, even when the first rotational axis lies on a center line of a yoke gap. In particular, the different distances of the conductor lines of two quadrants, located on one side of a first rotational axis, to the first rotational axis, result in a significant variation of the corresponding torques. In this specific embodiment as well, different torques may be generated on the four quadrants by a current flow through a coil. Accordingly, the conductor lines may also be configured on the intermediate frame in such a way that the quadrants have a different number of conductor lines.

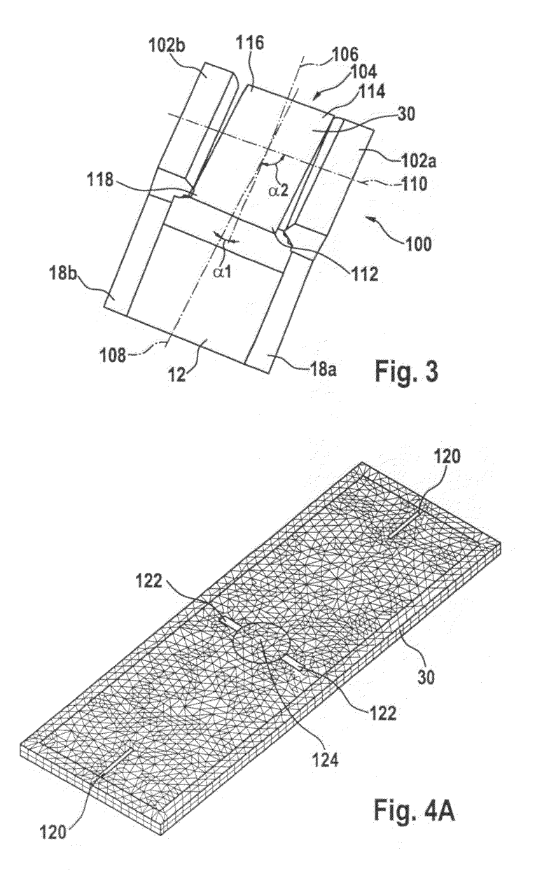

FIGS. 4A and 4B show a front and a rear side of an intermediate frame including a control element designed as a mirror plate.

Intermediate frames 30 depicted in FIGS. 4A and 4B may be installed in a yoke gap of a magnetic yoke of one of the two specific embodiments described above. FIG. 4A shows a front side of two cardanic suspensions of mirror plate 124 via two outer torsion springs 120 and two inner torsion springs 122. FIG. 4B shows the rear side of the cardanic suspension of intermediate frame 30. Stiffening elements 126 mounted on the rear side of the intermediate frame are discernible.

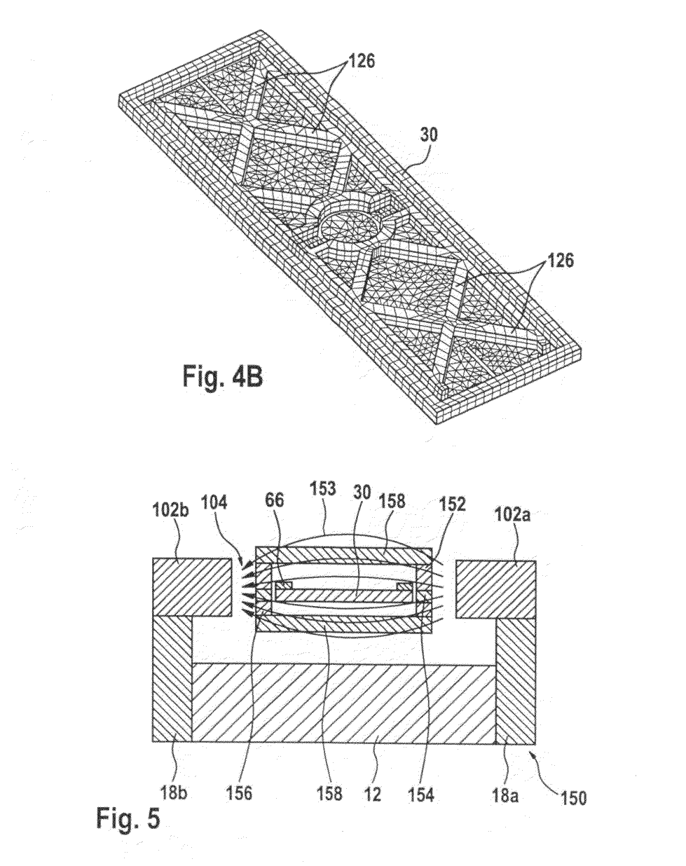

FIG. 5 shows a cross section for illustrating a third specific embodiment of the micromechanical component.

Illustrated micromechanical component 150 includes a magnetic yoke composed of a hard magnet 12, yoke arms 18a and 18b, and pole shoes 102a and 102b. In place of pole shoes 102a and 102b that are symmetric relative to a median plane of the magnetic yoke, the magnetic yoke may also have at least one pole shoe whose mass distribution is not symmetric relative to the median plane (not sketched) (see FIG. 1B).

An outer frame 152 is configured within yoke gap 104 between the two pole shoes 102a and 102b. Outer frame 152 is an integral part of a holder, for example, which is also assigned to the magnetic yoke having components 12, 18a and 18b and 102a and 102b. Outer frame 152 surrounds an intermediate frame 30 having conductor lines 66 designed as a coil and a control element (not sketched). The adjusting element of intermediate frame 30 is a cardanically suspended mirror plate, for example, which is adjustable by a Lorentz force. For the sake of clarity, the at least one outer spring, via which intermediate frame 30 is connected to outer frame 152, and the at least one inner spring between the intermediate frame and the control element are not shown in FIG. 5.

Conductor lines 66 are preferably formed lithographically as a planar coil on intermediate frame 30. It is advantageous in this context when conductor lines 66 are formed to be as high as possible, and the distance between conductor lines 66 is selected to be as small as possible. It is particularly advantageous for conductor lines 66 to be formed from a plurality of layers.

Intermediate frame 30 may be constructed from a silicon layer. Frame parts 154 may also be formed which are integral parts of outer frame 152. Two cap elements 158 may be fastened to frame part 154 by connecting components 156 in such a way that both a top side, as well as also a bottom side of intermediate frame 30 are covered. Outer frame 152, composed of frame parts 154, connecting components 156 and cap elements 158, may have an airtight design. Thus, intermediate frame 30, together with conductor lines 66 and the control element, are well protected from contamination during an operation of micromechanical component 150.

Outer frame 152 may be positioned in yoke gap 104 in such a way that the rotational axes of the control element are oriented at inclination angles unequal to 0° and unequal to 90° relative to a center line of yoke gap 104. Since this type of positioning of the intermediate frame in yoke gap 104 has already been described with reference to FIG. 3, it is not discussed here in detail again.

In the case that current flows through conductor lines 66, it is intended that the torques already described act upon intermediate frame 30. It is advantageous when magnetic field lines 153 of the magnetic field of the magnetic yoke are directed to the inside of outer frame 152 in such a way that a high enough field strength of the magnetic field is present in the area of conductor lines 66.

Possible ways for increasing the field strength of the magnetic field present in the area of conductor lines 66 are described in the following.

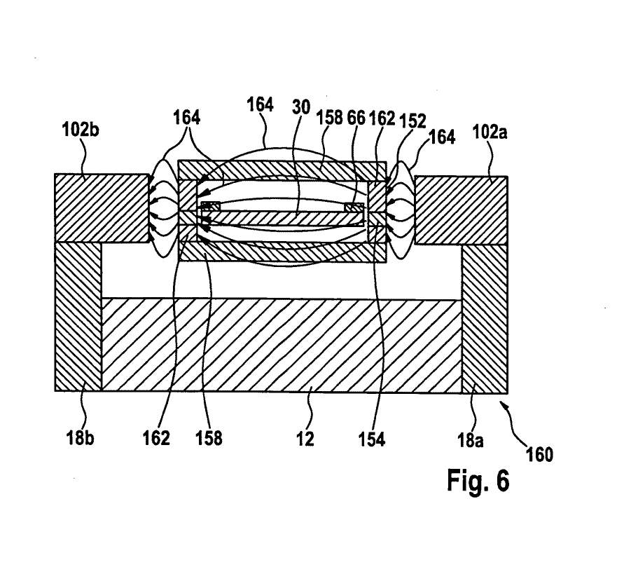

FIG. 6 shows a cross section for illustrating a fourth specific embodiment of the micromechanical component.

Illustrated micromechanical component 160 has components 12, 18a and 18b, 102a and 102b and 152, already described above. To supplement the micromechanical component described with reference to FIG. 5, connecting components 162, which are used to fasten cap elements 158 to frame part 154, are made of a soft magnetic material.

As is illustrated with reference to magnetic field lines 164, the magnetic field is concentrated by the use of permeable connecting components 162 in the areas of conductor lines 66. Thus, the magnetic field is effectively directed via connecting components 162 to the inside of outer frame 152. In place of or in addition to the iron particles, the soft magnetic material may also be mixed with other metal particles to form connecting components 162.

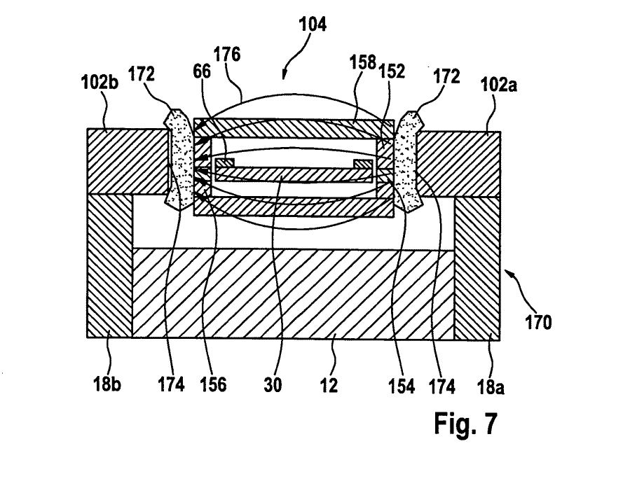

FIG. 7 shows a cross section for illustrating a fifth specific embodiment of the micromechanical component.

In comparison to the specific embodiment described with reference to FIG. 5, micromechanical component 170 has the additional feature that outer frame 152 is bonded by a permeable adhesive 172 to pole shoes 102a and 102b. An improved stability of micromechanical component 170 is effected by using permeable adhesive 172 to fix outer frame 152 within yoke gap 104. Permeable adhesive 172 is preferably placed on contact surfaces 174 of pole shoes 102a and 102b, which adjoin yoke gap 104.

The effect of permeable adhesive 172 is analogous to that of reducing the distance between contact surfaces 174 and outer frame 152. This is illustrated by magnetic field lines 176. Permeable adhesive 172 may be rendered permeable by a high concentration of metal particles, for example iron particles.

In a further refinement, connecting parts 156, which are used to fasten cap elements 158 to frame part 154, may likewise have particles of a conductive material added thereto and/or be formed of a permeable adhesive.

Using permeable adhesive 172 has the same effect as reducing the distance between coil device 66 and contact surfaces 174. Thus, in particular, a minimum distance between coil device 66 and contact surfaces 174 tends to zero.

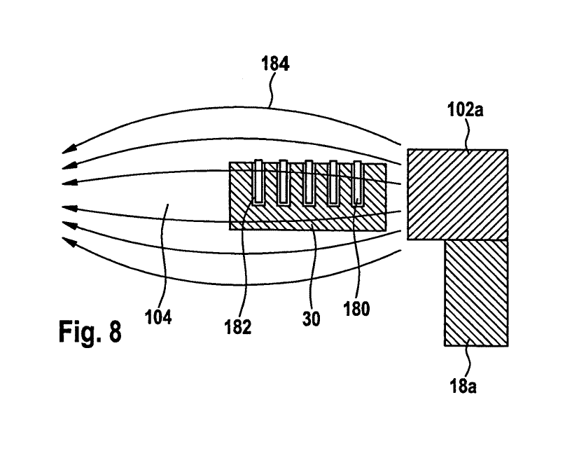

FIG. 8 shows a detail of a cross section for illustrating a sixth specific embodiment of the micromechanical component.

A magnetic yoke is schematically reproduced in FIG. 8 by a yoke arm 18a and a pole shoe 102a fastened to yoke arm 18a. A yoke gap 104 having a magnetic field illustrated by magnetic field lines 184 is situated between sketched pole shoe 102a and a pole shoe (not shown). Configured inside yoke gap 104 is an intermediate frame 30 having an adjustable control element (not shown). In this context, intermediate frame 30 may correspond to the specific embodiment described above.

Pole shoes 102a have a mass distribution that is symmetric relative to a median plane of the magnetic yoke. In place of pole shoes 102a, pole shoes, whose mass distribution is not symmetric relative to the median plane of the magnetic yoke (see the example of FIG. 1B), may also be fastened to yoke arms 18a.

Intermediate frame 30 schematically reproduced in FIG. 8 includes conductor lines 180 which are configured in trenches 182. Thus, the through-flow surface of conductor lines 180 for magnetic field lines 184 of the magnetic field is relatively large. Therefore, conductor lines 180 formed in trenches 182 have a relatively high aspect ratio. This high aspect ratio has an effect similar to that of a reduced distance between conductor lines 180 and pole shoes 102a. Thus, the result is a high current carrying capacity and a small distance to the magnetic field.

As an alternative or as a supplement to conductor lines 180 configured in trenches 182, additional conductor lines may also be configured on the rear side of the control element. In this manner, field lines 184 are able to be directed in a more targeted manner to conductor lines 180 formed within or outside of trenches 182.

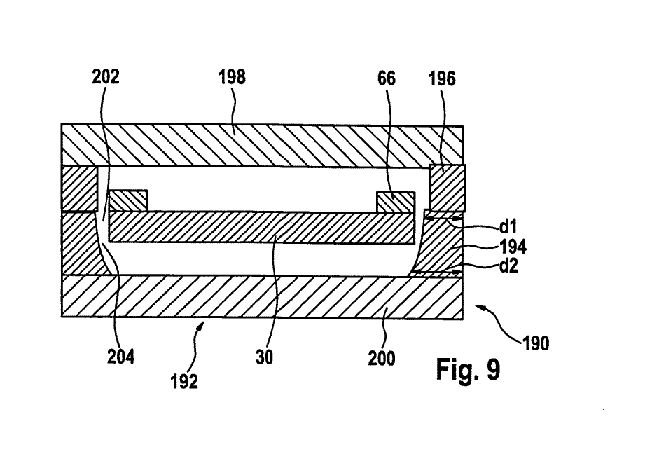

FIG. 9 shows a cross section through an outer frame for illustrating a seventh specific embodiment of the micromechanical component.

An illustration of the magnetic yoke of micromechanical component 190 was omitted in FIG. 9. However, micromechanical component 190 may also have a magnetic yoke in accordance with the specific embodiments described with reference to FIGS. 1A, 1B, 2A, 2B, 3 and 5 through 7.

Outer frame 192 illustrated in FIG. 9 includes a frame part 194 which, together with intermediate frame 30, is constructed from a silicon and/or glass layer. A top covering cap 198 is fastened to frame part 194 by a connecting component 196 mounted on a top side of outer frame part 194. A bottom covering cap 200 is fastened directly to a bottom side of frame part 194.

Outer frame 192 composed of components 192 through 200 may surround the intermediate frame, the control element (not shown), and conductor lines 66 in an airtight manner. This ensures that components 30 and 66 are well protected inside outer frame 192.

Intermediate frame 30 and frame part 194 are preferably constructed from the common silicon and/or glass layer by etching a first etch trench 202, starting from a front side of intermediate frame 30, and etching a second etch trench 204, starting from a bottom side of intermediate frame 30. A more stable frame part 194 may be obtained by introducing an undercut when etching second etch trench 204 from the bottom side.

Thus, the top side of frame part 194 has a first diameter d1, and its bottom side has a second diameter d2, second diameter d2 being larger than first diameter d1. In this context, a diameter d1 or d2 is understood to be a width through a compact section of frame part 194.

To ensure a good movability of intermediate frame 30, it is advantageous when frame part 194 configured at a small distance to intermediate frame 30 is designed to be comparatively thin in its top regions having diameter d1. In addition, the thinning effect corresponds to a reduction in the distance between the conductor lines and the pole shoes (not shown). On the other hand, the base of the frame part having the larger second diameter d2 enhances the mechanical stability of frame part 194, and thus the mechanical stability of outer frame 192.

Thus, frame part 194 features a curvature disposed adjacently to the inner volume of outer frame 192. This shape of frame part 194 permits a good movability of intermediate frame 30 and of control element (not shown).

It should be pointed out that the micromechanical components described in the top sections are able to be manufactured with dimensions of approximately 5 to 10 mm. This makes it possible for the described micromechanical components to be installed in a small micro device, such as a cell phone, for example.

1-11. (canceled)

12. A magnetic yoke comprising:
a magnet having a magnetization direction on which a first yoke arm and a second yoke arm are mounted in such a way that the magnet and the two yoke arms define a yoke intermediate space extending from a front side to a rear side of the magnetic yoke; and
a first pole shoe configured on the first yoke arm and a second pole shoe configured on the second yoke arm between which a yoke gap is located;
the first pole shoe having a first width at a first end on the front side of the magnetic yoke, in parallel to the magnetization direction of the magnet, and having a second width unequal to the first width at a second end facing opposite the first end on the rear side of the magnetic yoke, in parallel to the magnetization direction of the magnet.

13. A micromechanical component comprising:
a magnetic yoke having a magnet on which a first yoke arm and a second yoke arm are mounted in such a way that the magnet and the two yoke arms define a yoke intermediate space; and having a first pole shoe configured on the first yoke arm and a second pole shoe configured on the second yoke arm between which a yoke gap is located;
an intermediate frame, which is mounted within the yoke gap by at least one first spring that is oriented along a first axis and which frames a control element, which is connected to the intermediate frame via at least one second spring that is oriented along a second axis; and
conductor lines, which are designed as a coil and are permanently configured on the intermediate frame; the intermediate frame being subdividable by the first axis and the second axis into four quadrants, of which a first and a second quadrant are disposed adjacently to the first pole shoe, and a third and a fourth quadrant are disposed adjacently to the second pole shoe;
the intermediate frame being configured in the yoke gap in such a way, and the conductor lines being configured on the intermediate frame in such a way that a mean distance of the conductor lines of the first quadrant to the first pole shoe is smaller than a mean distance of the conductor lines of the second quadrant to the first pole shoe.

14. The micromechanical component as recited in claim 13, having a yoke intermediate space extending from a front side to a rear side of the magnetic yoke, the first pole shoe having a first width at a first end on the front side in parallel to the magnetization direction of the magnet, and having a second width unequal to the first width at a second end facing opposite the first end on the rear side, in parallel to the magnetization direction.

15. The micromechanical component as recited in claim 13, wherein a center line of the yoke gap is definable and lies in a plane defined by the first rotational axis and the second rotational axis; and wherein at least one of the first rotational axis and the second rotational axis is oriented relative to the center line at an inclination angle (α1, α2) unequal to 0° and unequal to 90°.

16. A micromechanical component comprising:
a magnetic yoke having a magnet on which a first yoke arm and a second yoke arm are mounted in such a way that the magnet and the two yoke arms define a yoke intermediate space; and having a first pole shoe configured on the first yoke arm and a second pole shoe configured on the second yoke arm between which a yoke gap is located;
an intermediate frame, which is mounted within the yoke gap by at least one first spring that is oriented along a first axis and which frames a control element, which is connected to the intermediate frame via at least one second spring that is oriented along a second axis;
conductor lines, which are designed as a coil and are permanently configured on intermediate frame; and
an outer frame, which surrounds the intermediate frame and is formed at least partially from a permeable material or is fastened by a permeable adhesive to at least one of the first pole shoe and to the second pole shoe.

17. The micromechanical component as recited in claim 16, wherein at least one of the permeable material of the outer frame and the permeable adhesive contains metal particles.

18. A method for manufacturing a magnetic yoke, comprising:
mounting a magnet having a magnetization direction between a first yoke arm and a second yoke arm in such a way that the magnet and the two yoke arms define a yoke intermediate space extending from a front side to a rear side of the magnetic yoke;
mounting a first pole shoe on the first yoke arm, the first pole shoe being formed in such a way that the first pole shoe has a first width at a first end on the front side of the magnetic yoke, in parallel to the magnetization direction of the magnet, and having a second width unequal to the first width at a second end facing opposite the first end on the rear side of the magnetic yoke, in parallel to the magnetization direction of the magnet; and
mounting a second pole shoe on the second yoke arm in such a way that a yoke gap is situated between the first pole shoe and the second pole shoe.

19. The micromechanical component as recited in claim 16, the magnet being fastened between a first flux-concentrating layer and a second flux-concentrating layer; and the first yoke arm, together with the first pole shoe mounted thereon, being fastened to the first flux-concentrating layer, and the second yoke arm, together with the second pole shoe mounted thereon, being fastened to the second flux-concentrating layer.

20. A method for manufacturing a micromechanical component, comprising:
mounting a magnet between a first yoke arm and a second yoke arm in such a way that the magnet and the two yoke arms define a yoke intermediate space;
mounting a first pole shoe on the first yoke arm and a second pole shoe on the second yoke arm in such a way that a yoke gap is situated between the first pole shoe and the second pole shoe;
configuring an intermediate frame within yoke gap by at least one first spring oriented along a first axis and a control element in an opening of the intermediate frame, the control element being connected to the intermediate frame via at least one second spring that is oriented along a second axis; and
permanently configuring conductor lines as a coil on the intermediate frame;
the intermediate frame being configured in the yoke gap in such a way, and the conductor lines being configured on the intermediate frame in such a way that, after subdividing the intermediate frame by the first axis and the second axis into four quadrants, of which a first and a second quadrant are disposed adjacently to the first pole shoe, and a third and a fourth quadrant are disposed adjacently to the second pole shoe, a mean distance of the conductor lines of the first quadrant to the first pole shoe is smaller than a mean distance of the conductor lines of the second quadrant to the first pole shoe.

21. A method for manufacturing a micromechanical component, comprising:
mounting a magnet between a first yoke arm and a second yoke arm in such a way that the magnet and the two yoke arms define a yoke intermediate space;
mounting a first pole shoe on the first yoke arm and a second pole shoe on the second yoke arm in such a way that a yoke gap is situated between the first pole shoe and the second pole shoe;
configuring an intermediate frame within the yoke gap by at least one first spring oriented along a first axis and a control element in an opening of the intermediate frame; the control element being connected to the intermediate frame via at least one second spring that is oriented along a second axis;
permanently configuring conductor lines as a coil on the intermediate frame; and
configuring the intermediate frame within an outer frame, the outer frame being formed at least partially from a permeable material or being fastened by a permeable adhesive to at least one of the first pole shoe and the second pole shoe.

22. The manufacturing method as recited in claim 21, wherein the conductor lines are formed as buried conductor lines.
